(19) United States
(12) Patent Application Publication
(10) Pub. No.: US 2006/0162514 A1
(43) Pub. Date: Jul. 27, 2006

(54) Adjustable holding table

(75) Inventors: Gabriel Sirois, St-Georges (CA); Dominik Roy, St-Marie (CA)

Correspondence Address: DARBY & DARBY P.C., P. O. BOX 5257, NEW YORK, NY, 10150-5257, US

(73) Assignee: Matiss inc., St-Georges (CA)

(21) Appl. No.: 11/261,425

(22) Filed: Oct. 27, 2005

Related U.S. Application Data
(60) Provisional application No. 60/645,759, filed on Jan. 24, 2005.

(51) Int. Cl. B26D 1/00; B26D 7/06

(52) U.S. Cl. 83/13; 83/448; 83/452

(57) ABSTRACT

The invention relates to an adjustable cutting plate assembly for food products cutting apparatus. It comprises a cutting plate for supporting a food product to be cut, the food product having a predetermined configuration and the cutting plate having an upper face provided with at least one arrangement of at least one discrete connection interface disposed to conform to said predetermined configuration. It also comprises at least one stop guide removably connectable to said at least one discrete connection interface for laterally holding the food product in place while it is being cut. The interfaces are preferably grooves. The invention also relates to a method for holding food products to be cut. It enables adequate holding of the food product to be efficiently cut.

### FIELD OF THE INVENTION

The present invention generally relates to the field of automated equipment for cutting food products, and more specifically to an adjustable holding table for maintaining a food product in place while it is being cut.

### BACKGROUND TO THE INVENTION

In order to adapt to the growing market, food and food-processing companies must research possible solutions to increase their rate of production. Industry requires automated equipment in order to increase its capacity of production and transformation of food products. Cutting food products is a transformation step in which products are cut according to various geometrical models by a mechanical process which is more or less automated.

With the goal of increasing profitability of automated equipment practices, food product companies research cutting machines that can satisfy specific geometrical constraints for a wide variety of products. Automated machine producers make an effort to create machines that are simultaneously adaptable to many products. For example, different cutting model geometries are programmed into automats in order to perform many different types of cutting on the same machine.

Cutting certain products requires the presence of lateral supports to restrict the products' movement during the insertion of the cutting tool. Holding trays are used to prevent the product from shifting during the automated operations. The trays currently used In industry are fabricated as a function of the specific needs of a product and adapted to a particular cutting model.

In the prior art, there are various patents that disclose devices and methods for holding a food product to be cut or sliced. More notably, United States patents U.S. Pat. No. 4,386,465 (EZAKI), U.S. Pat. No. 6,182,549 (ALBRIGHT et al.) and United States patent application US 2005/0115378 A1 (KUCHLER) all describe cutting plates including adjustable retaining elements for holding food products.

EZAKI teaches an apparatus for cutting frozen foods comprising a cutting plate and seizing members whose positions are adjustable relative to the product to be cut. The position of a seizing member is adjusted radially by sliding the member back or forward on corresponding screw rods.

ALBRIGHT et al. teach an apparatus for cutting flat articles. This apparatus comprises a cutting bar mounted to a cutting plate via two arms having a plurality of perforations. Projections rising from the cutting plate pass through corresponding perforations depending an where the user wishes to place the cutting bar. However, this apparatus is destined for the tissue and cloth industry and is not ideal for cutting food products.

KUCHLER teaches a cutting machine for cutting food products, such as cheeses and meats, into slices. The machine includes a cutting plate on which are provided two slidable fence-walls and one fixed wall. The fence-walls slide in order to adapt to different sizes of food products, and apply lateral pressure on the food product as the latter is sliced.

None of the aforementioned prior art references disclose adjustable holding means that are incorporated into the cutting assembly in a discrete way, that is, that can be attached to the cutting plate in a fixed position and then removed from the cutting plate and reattached in a different fixed configuration. Particularly in pastry and cake cutting applications, where the food products are often light, delicate and/or crumbly, an inventive adjustable cutting plate assembly carrying with it numerous advantages over the prior art, in most cases, known cutting assemblies that have continuous holding means (such as EZAKI and KUCHLER) that are often difficult to adjust from one predetermined configuration to another. Cutting plates should be able to hold produce of a variety of peripheral configurations and internal consistencies. Furthermore, new holding and cutting assemblies should optimize the adaptation capacity of new automated machines, for the handling and cutting of new food products.

There is therefore a current need in the industry for cutting plate and holding assemblies that satisfy the specific needs of many products simultaneously.

### SUMMARY OF THE INVENTION

The present invention provides an adjustable cutting plate assembly, also called holding trays herein, that satisfies the above-mentioned needs and has various advantages and differences over the prior art.

The invention consists of a new generation of holding trays for food products of different geometries. Using such a tray, many different types of food product geometries, more specifically peripheral geometries, can be maintained in place while being cut in an automated process.

More particularly, the present invention provides an adjustable cutting plate assembly for food products cutting apparatus. The cutting plate assembly includes a cutting plate for supporting food products of various predetermined peripheral configurations one at a time. The cutting plate includes an upper face provided with a plurality of arrangements, each one of the arrangements including at least one discrete connection interface and conforming with a respective one of the peripheral configurations. The assembly further includes at least one stop guide associated with each one of the arrangements respectively, the at least one stop guide being removably connectable to the at least one discrete connection interface for laterally holding the food product in place while it is being cut.

Also according to the present invention, there is provided a food product holding method for supporting at least one food product to be cut on a cutting plate assembly. The method comprises the following steps:

a) providing an adjustable cutting plate assembly as defined hereinabove;

b) placing a first food product of a first peripheral configuration onto the cutting plate;

c) determining the arrangement that conforms with the given peripheral configuration; and

d) connecting to the discrete connection interfaces of the arrangement determined in step c), the stop guide associated with the arrangement of step c), for laterally holding the food product.

Preferably, at least one of the arrangements is rectangular. Advantageously, there are numerous rectangular and circular arrangements provided on the cutting plate for all sorts of different peripheral geometries of food products.

It is also preferable that the discrete connection interfaces take the form of grooves into which the step guides are removably insertable.

In accordance with a preferred embodiment of the invention, each interchangeable stop guide comprises a base and holding digits preferably extending vertically therefrom, for holding food products in place. The holding digits are preferably flexible and spaced one from another according to the dimensions of the desired portions to be cut, as the cutting tool passes between the digits.

### BRIEF DESCRIPTION OF THE DRAWINGS

A preferred embodiment of the adjustable holding table is represented in FIGS. 1 to 7.

FIG. 1 is an exploded perspective view of the adjustable holding table system, according to a preferred embodiment of the invention.

FIG. 2 is a perspective view of the cutting plate, according to a preferred embodiment of the invention.

FIGS. 3 and 4 are perspective views of two cutting plates, showing different possible configurations of the stop guides, according to a preferred embodiment of the invention.

FIGS. 5 and 6 are perspective views of two cutting plates, showing possible configurations of the stop guides, according to a preferred embodiment of the invention.

FIG. 7 is a perspective view of the cutting plate and stop guides, according to a preferred embodiment of the invention.

While the invention will be described in conjunction with an example embodiment, it will be understood that it is not intended to limit the scope of the invention to such embodiment. On the contrary, it is intended to cover all alternatives, modifications and equivalents as may be included as defined by the appended claims.

### DESCRIPTION OF A PREFERRED EMBODIMENT

In the following description, similar features in the drawings have been given similar reference numerals and in order not to weigh down the figures, some elements are not referred to in some figures if they were already identified in a preceding one.

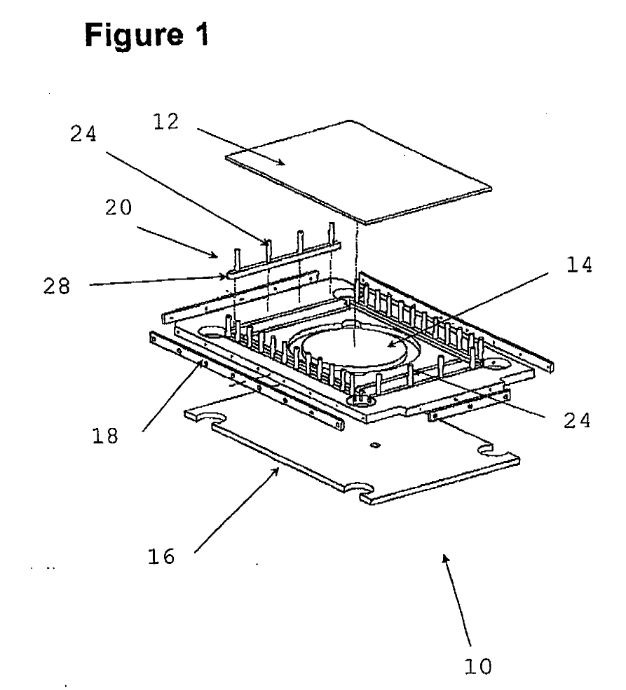

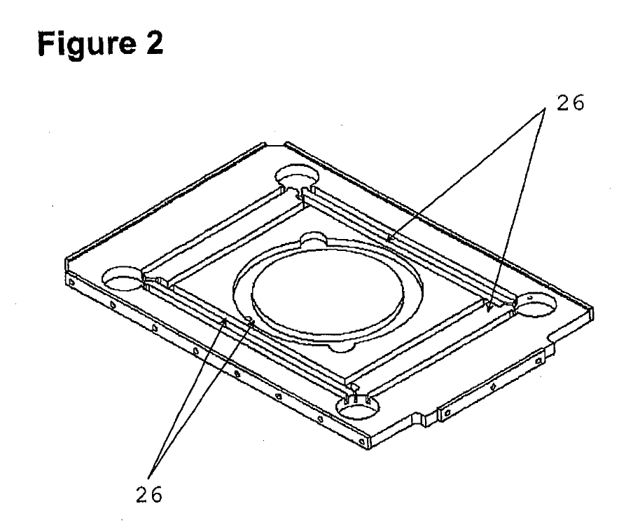

The adjustable holding plate assembly (10), also called the adjustable cutting plate assembly, is shown in its preferred embodiment in FIGS. 1 to 7. FIG. 1 shows the various components that make up the assembly (10). The adjustable holding plate assembly (10) is preferably part of a larger system (not shown) for cutting food products, advantageously an automated cutting machine. In accordance with a preferred aspect of the invention, the products that are to be cut (not shown) are transported to the machine via transport trays (12). The transport trays (12) containing the food product to be cut are set down on the cutting plate (14). During the cutting, the adjustable holding table assembly (10) is arranged in a way to carry out different predefined and specific cutting patterns on the product (e.g. rectangular sections, pointed sections, etc.).

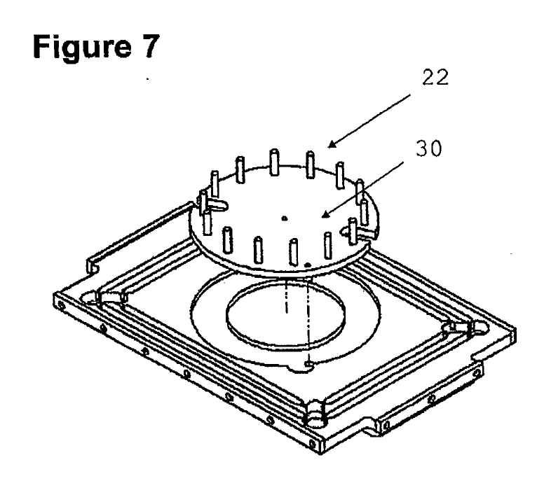

The adjustable holding table assembly (10) further comprises a supporting plate (16), lateral plates (18) and, according to a preferred embodiment of the invention, a set of interchangeable removable stop guides (20, 22). FIGS. 1 and 3 to 6 show the preferred embodiment of the removable stop guides taking the form of lateral segments (20). FIG. 7 shows a second preferred embodiment of the removable stop guides having a circular guide plate (22) formation. Indeed, the stop guides are of different geometries: they are of similar or different lengths and widths, and are curved, straight, or of any other design according to the corresponding shape of the food product to be cut. By changing these stop guides (20, 22), the holding table (10) is able to adapt to the geometries of different products. Advantageously, the removable stop guides (20, 22) are provided with holding digits (24) to better hold the food product.

The cutting plate (14) is also provided with at least one predetermined arrangement of discrete connection interfaces (26). Preferably, the predetermined arrangements are suited for holding rectangular or circular food products, as shown in FIGS. 1 to 7. However, the predetermined arrangement can also take the form of any other arrangement by which food products may be cut, such as elliptical, star-form, long-and-skinny, or irregular arrangements, as may be desired.

The discrete connection interfaces (26) enable the stop guides (20, 22) to be removably connected to the cutting plate. The stop guides (20, 22) and connection interfaces (26) must be engagable with each other. The connection interfaces (26) are advantageously grooves, as shown in FIGS. 1 to 7, which have preferably been machined into the solid cutting plate (14), but they can also take the form of holes into which connection rods are inserted, or projections that engage recesses in the stop guides. By “discrete” it is meant that they are predetermined and have a limit-that is, a border-and may be differentiated from “continuous” connections which are found in the prior art. Continuous connections enable an infinite number of arrangements according to where a holding element is slid on a continuous connection such as a screw rod or sliding latch. Sliding along and screwing in or out are examples of non-discrete connections, as the connection site moves as the element connected thereto moves. The discrete connection interfaces (26) of the present invention do not move but are predetermined according to the geometry of the food is products to be cut, and enable the removable stop guides (20, 22) engaging therewith to be substantially fixed in place during the cutting operation.

It could also be envisioned that the arrangement of discrete connection interfaces (26) can be movable on the cutting plate (14). The cutting plate (14) may thus be subdivided into movable sections that, when abutted in certain arrangements, form a desired arrangement of connection interfaces (26). In that sense, the discrete connection interfaces (26) are movable, but only to preset a desired arrangement before the stop guides (20, 22) are connected, according to a predetermined cutting arrangement.

The stop guides (20, 22) each preferably comprise a base (28, 30) that is insertable into the grooves. For the lateral segment stop guides (20) the bases preferably take the form of rectangular bars (28); for the circular plate shaped stop guides (22), the bases take the form of disk-shaped plates (30). When inserted into the corresponding grooves, the top surface of the base (28, 30) is advantageously flush with or below the upper surface of the cutting plate. The holding digits (24) extend upward and above the surface of the cutting plate (14). This is to facilitate that the cutting tool (not shown) can pass in between the holding digits (24) without hitting the base (28, 30) of the stop guide (20, 22).

Considering the lateral segment stop guide (20), the bases (28) preferably do not laterally hold the food products, but moreover support the vertical holding digits (24), as shown in FIGS. 1, 3, 4, 5 and 6. Thus the holding digits (24) laterally support the product as the cutting tool cuts in between them. The cutting tool can be any kind of food cutting knife, saw or blade, known to a skilled workman. The bases (28), when provided with holding digits (24), preferably project above the grooves (26) very little or not at all. The bases (28) substantially fit into the grooves (26) and the holding digits (24) project therefrom. On the other hand, the bases (28) may slightly or substantially project from the grooves above the surface of the cutting plate (14), according to the desired cutting to be performed. The bases (28) are preferably lateral segments but can also take other insertable forms, such as a disk-shaped plate (30) or other multisided (square, circular) segments. Furthermore, the bases (28, 30) are preferably rigid and made of a metal such as stainless steel. However, the bases (28, 30) may also be flexible and thus able to be inserted into various different grooves (26), such as straight and curved grooves. In another conception of the stop guides, the bases (28, 30) are connectable to each other, thus allowing two smaller stop guides to be connected to make one larger stop guide.

The supporting plate (16) of the assembly (10) is preferably connected to an automated machine (not shown) by an adjustable mechanical connection (not shown). The cutting plate (14) is solidly fixed to the supporting plate (16). The supporting plate (16) has the function of reinforcing the cutting plate (14). The cutting plate (14) precisely positions the products during the cutting by means of interchangeable, removable stop guides (20, 22). The stop guides (20, 22) are preferably arranged in grooves (26) machined in the cutting plate (14). The food products, having a tendency to shift during the intrusion of the cutting tool, are held in place by the bases (28, 30), and/or by the holding digits (24), thus ensuring a cut that is clean and precise and portions that have constant dimensions. The use of holding digits (24) particularly allows the portions cut towards the interior to be held.

In general, the adjustable holding table assembly (10) decreases product positioning errors during successive cuts, and thus increases the overall precision of the cutting system. More specifically, the number and placement of the holding digits (24) can vary according to different cutting patterns. To advantageously assure that the products are well maintained in place, for many cutting operations of the present invention, it is important that each exterior face of the portions is held by at least one digit (24). Moreover, the holding digits (24) must not be positioned in the cutting trajectories. The stop guides (20, 22) are interchangeable and the distance between the guides (20, 22) is defined as a function of the initial dimension of the product to be cut.

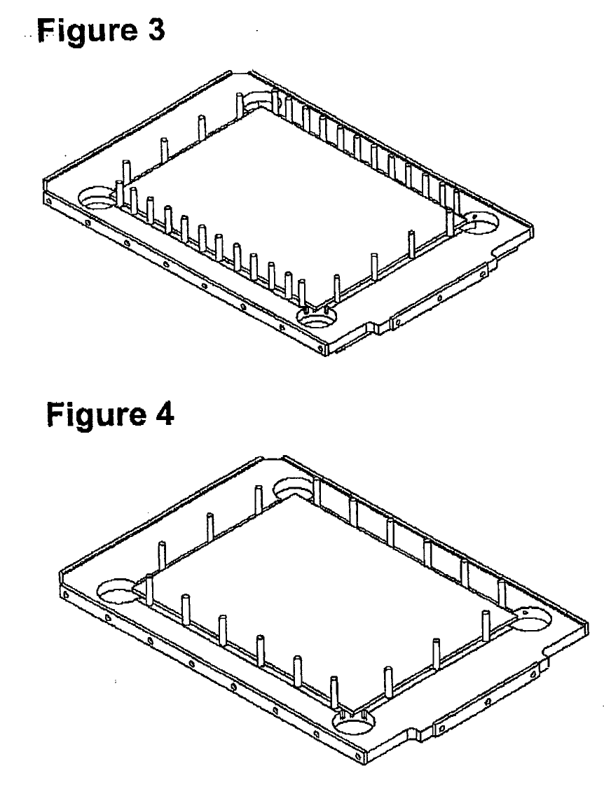

Different combinations and arrangements of stop guides (20, 22) allow each product to be cut in different specific geometric proportions. Preferably, when the products to be cut have the same initial dimensions but require a different cutting pattern (portions), the stop guides (20, 22) are changed for others for which, for example, the holding digits' (24) positioning is different. Changing the stop guide (20, 22) or holding digit (24) arrangement permits a same initial rectangular product to be cut into different portions. An example of different arrangements of the holding digits is apparent in FIGS. 3 and 4. The configuration of FIG. 3 enables a product to be cut into 12 rows and 4 columns. The configuration of FIG. 4 enables a product to be cut into 6 rows and 3 columns.

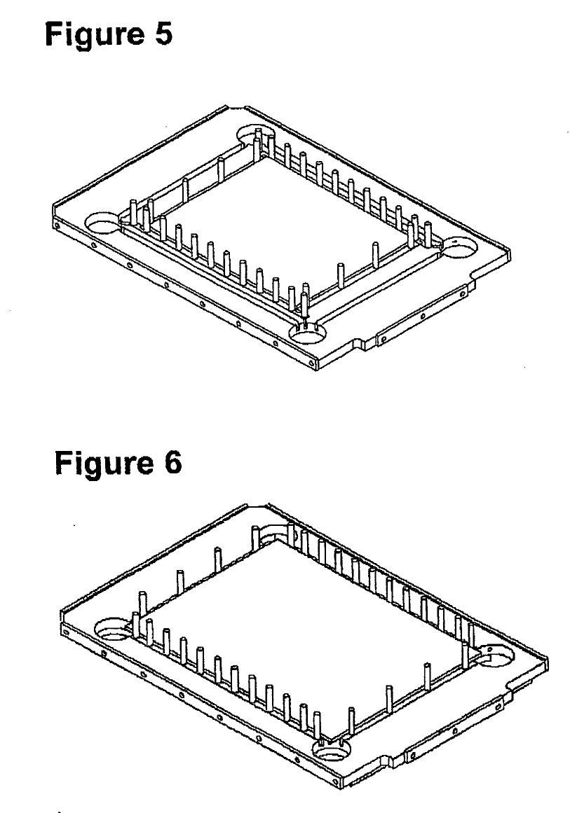

Furthermore, same configurations of stop guides and holding digits can be used for different shapes and sizes of food products. For example, FIGS. 5 and 6 show how different possible configurations of the stop guides (20, 22) enable rectangular products of different initial dimensions to be cut into equal portions.

In this case, the same stop guides with the same holding digit arrangements are used but in different grooves (26).

The holding digits (24) are preferably fixed in predetermined spacing arrangements on the bases (28, 30). On the other hand, the holding digits (24) themselves can be removably insertable in the bases (28, 30), and thus their arrangement (spacing) can be changed on the same base (28, 30) to enable a different cutting pattern. In this case, the bases (28, 30) are provided with holes or other attachment means into which the holding digits (24) are insertable.

Holding digits (24) are not, however, the only means of holding the food products in place to be cut into specific portions. Other holding means could include various arrangements of rods, wires, flat projections, or others, removable from or fixed within the base (28, 30) of the stop guides (20, 22), and suitable for resisting movement of a food product being cut. The holding digits may have different or similar lengths, widths and flexing abilities, and different holding digits (24) can be provided randomly or regularly on the bases (28, 30). When the products to be cut have different initial dimensions, different stop guides (20, 22) are inserted in the different grooves (26). Preferably, the arrangement of the holding digits (24) is a function of the cutting pattern of the product, and thus of the position of the portions.

This adjustable holding table assembly (10) also enables the possibility of cutting some rectangular products without having to use the holding digits (24) of the stop guides (20, 22). Certain dense food products do not move while being cut. In this case, the food product is placed on the cutting plate (14), or preferably on the transport tray (12), without the stop guides (20, 22). In this case, and the lateral plates (18) sufficiently hold the product on the cutting plate (14). Also, the lateral plates (18) and an arrangement of stop guides (20, 22) can function together to hold a food product in place.

The adjustable holding table assembly (10) is also adapted to cut round food products. This second preferred embodiment is shown in FIG. 7. To hold a round product, the rectangular stop guides (20) are replaced by a circular stop guide (22) placed in a circular groove at the center of the cutting plate (14). Again, the holding digits (24) are arranged on the circular base (30) in order to hold the portions during the cutting. The position of the digits (24) on the circular disk-shaped base (30) may change as a function of the diameter of the product to be cut.

Any number of stop guides (20, 22) can be used to make up a desired arrangement on the cutting plate (14). For example, four lateral segment stop guides (28) can be inserted to make a rectangular arrangement. Also three or two lateral segment stop guides (28) can be arranged to make a U- or L-shaped arrangement The arrangement is advantageously a closed shape that enables all sides of the food product to be held during cutting. However, depending on the cutting pattern and the properties of the product to be cut, the arrangement can be open as in U- or L-shaped arrangements.

In conclusion, the current invention presented herein is an improvement on the systems found in the market This adjustable holding table assembly (10) allows many food products to be cut while ensuring the products stability while inserting the cutting tool. This adjustable holding table (10) is used on automated food cutting machines and enables the same machine to cut many different food products. The cutting plate (14) uses interchangeable removable stop guides (20, 22) whose geometry is a function of the size of the initial product and the size of the desired portions. The stop guides are connected to discrete connection interfaces (26), which are preferably grooves. A main advantage of this system is the decrease in the number of plates required during the cutting of a variety of products and the increase in the adaptability of the automated machine.

The Figures represent one preferred embodiment of the system. The interchangeable stop guides (20, 22) comprise lateral segments (28) or circular base (30) preferably made of stainless steel, and holding digits (24) preferably made of rubber. The holding digits (24) are preferably flexible to allow some give and biasing ability during cutting; the food product therefore is less squished against the digit because the latter is biased away. The grooves (26) have rectangular dimensions for rectangular products and circular dimensions for circular products. Advantageously, holes are pierced into the four corners of the cutting plate as well as close to the circular grooves, in order to facilitate the manipulation of the products on the transport plates during product loading and unloading operations. In this preferred embodiment, each initial product to be cut has its own corresponding set of interchangeable removable stop guides (20, 22) able to cover the totality of available cutting patterns. On the other hand, it is possible to lay out different sets of stop guides (20, 22) in order to accommodate other products to be cut.

The stop guides (20, 22) are preferably changed and/or modified by an operator when a new product is to be cut. The cutting can be performed in an automated or non-automated manner.

The adjustable holding table assembly (10) is particularly suitable for use in a cutting machine or cutting assembly line for portioning pastries, cakes, pies and other bakery goods. The assembly is also suitable for cutting frozen goods that may slide while being cut, meats, cheeses, and other cuttable food products.

While one preferred embodiment of the invention was described above and illustrated in FIGS. 1 to 7, the invention is not limited to this one embodiment and many modifications can be made by a person skilled in the art while staying within the scope of the invention.

1. An adjustable cutting plate assembly for a food products cutting apparatus, the cutting plate assembly comprising:
a cutting plate for supporting food products of various predetermined peripheral configurations one at a time, the cutting plate comprising an upper face provided with a plurality of arrangements, each one of said arrangements comprising at least one discrete connection interface and conforming with a respective one of said peripheral configurations; and
at least one stop guide associated with each one of said arrangements, said at least one stop guide being removably connectable to said at least one discrete connection interface for laterally holding the food product in place while being cut.

2. Adjustable cutting plate assembly according to claim 1, wherein a first of said plurality of arrangements is a rectangular arrangement of a first size, used for cutting substantially rectangular food products.

3. Adjustable cutting plate assembly according to claim 2, wherein said plurality of arrangements comprises a second rectangular arrangement of a second size different from said first size, used for cutting substantially rectangular food products of a second size.

4. Adjustable cutting plate assembly according to claim 2 or 3, wherein,
said at least one discrete connection interface comprises straight connection interfaces; and
said at least one stop guide comprises straight bases removably connectable to said straight connection interfaces.

5. Adjustable cutting plate assembly according to claim 1, wherein at least one of said plurality of arrangements is a circular arrangement used for cutting substantially circular food products.

6. Adjustable cutting plate assembly according to claim 5, wherein:
said at least one discrete connection interface comprises a circular connection interface; and
said at least one stop guide comprises a circular base removably connectable to said circular connection interface.

7. Adjustable cutting plate assembly according to claim 1, wherein said at least one discrete connection interface comprises at least one groove into which a base of said at least one stop guide is removably insertable.

8. Adjustable cutting plate assembly according to claim 7, wherein said base comprises a top surface, said top surface being below or on a same plane as the upper face of the cutting plate, when said base is inserted into a corresponding one of said grooves.

9. Adjustable cutting plate assembly according to claim 8, wherein said at least one stop guide further comprises holding digits projecting upward from the base.

10. Adjustable cutting plate assembly according to claim 9, wherein the holding digits are cylindrical rods.

11. Adjustable cutting plate assembly according to claim 1, further comprising a transport tray onto which the food product is placed, and which removably rests on the cutting plate while the food product is cut.

12. Adjustable cutting plate assembly according to claim 1, wherein the adjustable cutting assembly is operatively connected to an automated cutting machine, the cutting plate assembly further comprising a supporting plate to support the cutting plate within said automated cutting machine.

13. A method for supporting and holding a food product to be cut, said method comprising the following steps:
a) providing the adjustable cutting plate assembly as defined in claim 1;
b) placing a first food product of a first peripheral configuration onto the cutting plate;
c) determining the arrangement that conforms with said first peripheral configuration; and
d) connecting to the at least one discrete connection interface of the arrangement determined in step c), the stop guide associated with said arrangement of step c), for laterally holding said food product.
